(19) United States
(12) Patent Application Publication
(10) Pub. No.: US 2016/0196229 A1
(43) Pub. Date: Jul. 7, 2016

(54) METHOD AND APPARATUS FOR MANAGING CONNECTIONS AMONG PLURAL COMPUTERS

(71) Applicant: FUJITSU LIMITED, Kawasaki-shi (JP)

(72) Inventor: Masao SHICHI, Kawasaki (JP)

(73) Assignee: FUJITSU LIMITED, Kawasaki-shi (JP)

(21) Appl. No.: 15/071,250

(22) Filed: Mar. 16, 2016

Related U.S. Application Data
(63) Continuation of application No. PCT/JP2013/075110, filed on Sep. 18, 2013.

(51) Int. Cl. G06F 13/40; G06F 13/362

(52) U.S. Cl. CPC G06F 13/4022; G06F 13/362

(57) ABSTRACT

A disclosed information processing method includes: obtaining, from a first processing unit of plural processing units and by using a computer, first information representing whether or not the first processing unit has a function of a switch and second information representing whether or not a setting of a logical network for plural ports in the first processing unit has been completed; determining, by using the computer, whether or not the plural ports can be used, by using at least the first information and the second information; and transmitting, to the first processing unit and by using the computer, information representing that the plural ports can be used or cannot be used.

### CROSS-REFERENCE TO RELATED APPLICATIONS

This application is a continuing application, filed under 35 U.S.C. section 111(a), of International Application PCT/JP2013/075110, filed on Sep. 18, 2013, the entire contents of which are incorporated herein by reference.

### FIELD

This invention relates to a technique for managing connections among plural computers.

### BACKGROUND

In ATCA (Advanced Telecom Computing Architecture), specifications for a chassis of a blade server and blades that are mounted in the chassis are regulated. A user can build a desired blade server by combining plural kinds of blades that comply with ATCA.

FIG. 1 illustrates an example of a blade server. In FIG. 1, slots 7 are provided in a chassis 1, and plural blades 5 are inserted into the slots 7. For example, there are blades that have functions of a server function (hereafter, referred to as server blades), or blades that have functions of a switch (hereafter, referred to as switch blades). Management cards 31 and 32 are mounted in the chassis 1. The management cards 31 and 32 manage the blades 5 in a processing sequence that is specified in the ATCA.

In ATCA, a management card collects information on the communication standard of the ports in the blades. When the communication standards between two blades coincide (for example, the communication standard for both blades is 10 GbE (Gigabit Ethernet)), the management card allows the use of the ports in both blades. However, it is not possible to avoid generation of a loop connection by this method, and problems such as a broadcast storm may occur.

A technique described below is known for managing blades in a blade server. More specifically, a shelf manager for managing plural blades is mounted on a shelf where plural blades are mounted. Plural blades and a shelf manager are connected by IPMB (Intelligent Platform Management Bus). The shelf manager includes a shelf-manager controller, and monitors and controls the operation of shelf parts such as the plural blades, a cooling fan, power supply and the like.

However, this technique does not present a method for avoiding the generation of loop connections in a blade server.

Patent Document 1: Japanese Laid-open Patent Publication No. 2011-60056

### SUMMARY

An information processing apparatus relating to this invention includes: a memory; and a processor configured to use the memory and execute a process. And the process includes: obtaining, from a first processing unit of plural processing units, first information representing whether or not the first processing unit has a function of a switch and second information representing whether or not a setting of a logical network for plural ports in the first processing unit has been completed; determining whether or not the plural ports can be used, by using at least the first information and the second information; and transmitting, to the first processing unit, information representing that the plural ports can be used or cannot be used.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting an example of a blade server;

FIG. 2 is a diagram depicting a processing sequence in activating a blade in accordance with ATCA;

FIG. 3 is a diagram depicting an example in which a loop connection occurs;

FIG. 4 is a diagram depicting an example in which the loop connection occurs;

FIG. 5 is a diagram depicting an example of a block diagram of the blade server;

FIG. 6 is a diagram depicting an example of a loop connection in the blade server;

FIG. 7 is a block diagram of the blade server in this embodiment;

FIG. 8 is a block diagram of a management card;

FIG. 9 is a block diagram of a server blade;

FIG. 10 is a block diagram of a switch blade;

FIG. 11 is a diagram depicting an example of data stored in a determination table storage unit;

FIG. 12 is a diagram depicting an example of data stored in a blade data storage unit;

FIG. 13 is a diagram depicting a processing flow of processing executed in activating a blade;

FIG. 14 is a diagram depicting an example of data stored in a management table storage unit;

FIG. 15 is a diagram depicting a processing flow of processing executed in activating a blade;

FIG. 16 is a diagram depicting a processing flow of processing executed in activating a blade;

FIG. 17 is a diagram depicting a processing flow of processing executed in activating a blade;

FIG. 18 is a diagram depicting a processing sequence of processing executed in state 2;

FIG. 19 is a diagram depicting a processing sequence of processing executed in state 4; and

FIG. 20 is a diagram depicting a processing flow of processing for monitoring blades by the management card.

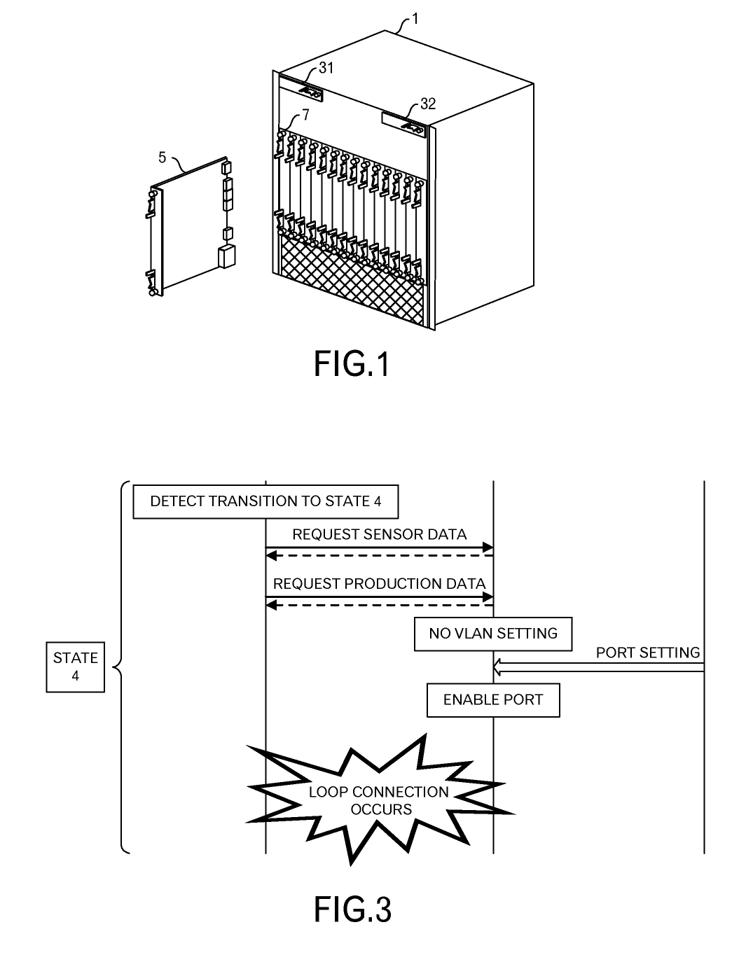

### DESCRIPTION OF EMBODIMENTS

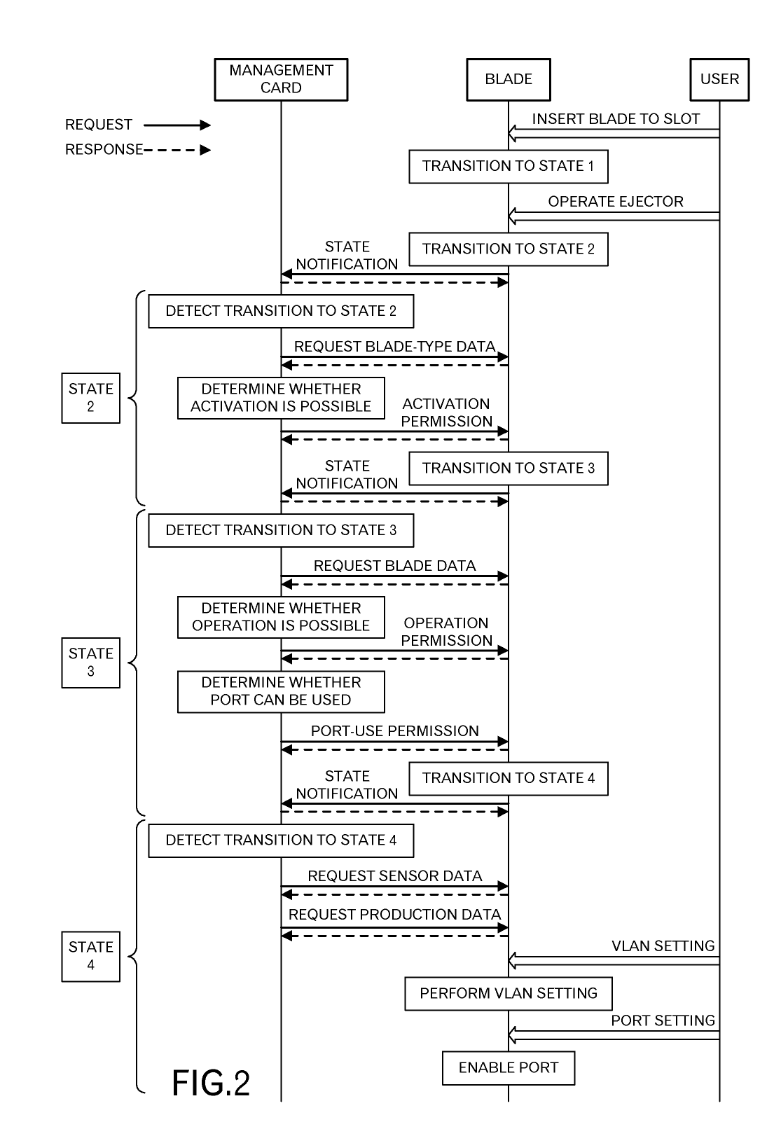

FIG. 2 illustrates a processing sequence when activating a blade in accordance with ATCA. FIG. 2 illustrates a timeline for processing by a management card, processing by a blade, and work by a user. The solid arrows represent requests, the dashed arrows represent responses, and white arrows represent work by a user.

As illustrated in FIG. 2, in ATCA, a blade passes through four states during activation. State 1 is a state in which basically the power is OFF, however, the blade is inserted into a slot of the chassis, and only the power to IPMC (Intelligent Platform Management Controller) is ON in order to communicate with the management card. State 2 is a state in which preparation for activation is complete, and it is possible to start activation in response to an instruction from the management card or in response to operation of an ejector that is mounted in the blade. State 3 is a state in which the blade is being activated, and is a state in which preparation for transitioning to an operating state is progressed by exchanging with the management card. State 4 is a state in which the blade is in operation, and parts other than the IPMC are also powered ON.

When a user inserts a blade into a slot, the blade transitions to state 1. In state 1, when the blade detects an operation of the ejector by a user, the blade transitions to state 2.

In state 2, when a blade transmits a state notification to a management card, the management card detects transition to state 2 and starts processing for activation. The management card requests data on a blade type, and obtains that data from the blade. When the management card determines that the blade is of a type that can be controlled by the management card, the management card transmits activation permission to the blade. When the blade receives the activation permission, the blade transitions to state 3.

In state 3, when the blade transmits a state notification to the management card, the management card detects the transition to state 3. The management card requests blade data, and obtains the blade data from the blade. The blade data includes information on the communication standard of the ports in the blade, and power data for calculating power distribution. The management card determines whether or not operation is possible according to the power distribution that was calculated from the power data, and when the operation is determined to be possible, the management card transmits operation permission to the blade. Moreover, the management card determines whether or not the communication standard satisfies a specified condition. More specifically, the management card determines whether or not the communication standard of the blade being activated coincides with the communication standard of the opposed blade. When the communication standard satisfies a specified condition, the management card transmits permission to use the ports to the blade. When the blade receives permission to use the ports, the blade transitions to state 4.

In state 4, when the blade transmits a state notification to the management card, the management card detects transition to state 4. The management card sends a request for sensor data for detecting abnormalities, and obtains sensor data from the blade. Moreover, the management card sends a request for production data that includes information on the production of the blade, and obtains the production data from the blade. Then, when a user inputs a Virtual Local Area Network (VLAN) setting for the ports of the blade, the blade performs the VLAN setting. Moreover, when the user inputs other settings for the ports, the blade performs that other setting for the ports.

In ATCA, the blade is activated by performing processing such as described above.

However, depending on the timing of the VLAN setting by the user, a loop connection may be generated between blades. FIG. 3 illustrates an example of a loop connection occurs due to a VLAN setting by the user not being performed. In the example in FIG. 3, in state 4, another setting is performed for the ports before the VLAN setting is performed, and the ports are enabled. In this case, plural ports of the Local Area Network (LAN) switch of the blade are not logically divided according to VLAN, and communication between plural ports becomes possible. This may become the cause of a loop connection being generated.

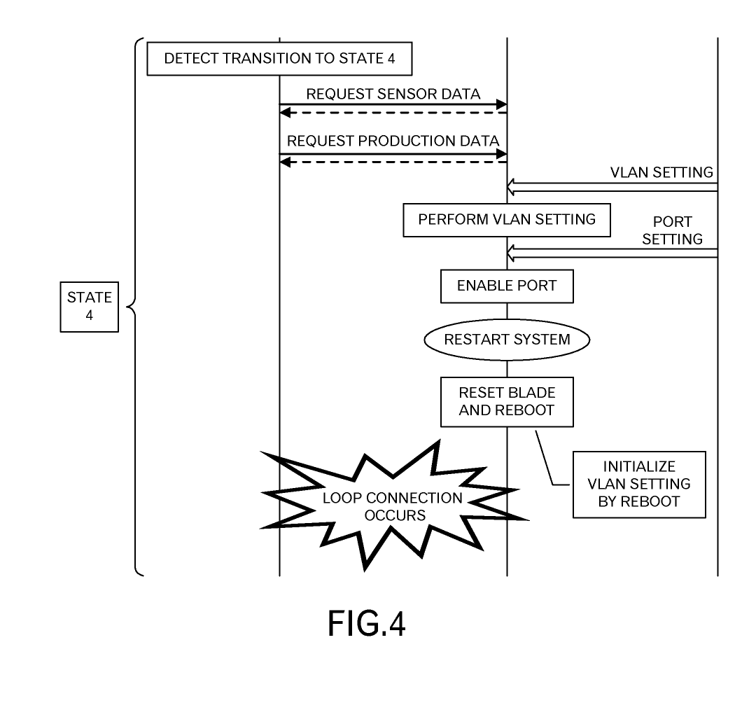

Moreover, when the VLAN setting is initialized by resetting the blade, a loop connection may be generated between blades. FIG. 4 illustrates an example of a loop connection being generated by a VLAN setting being initialized. In the example of FIG. 4, in state 4, after the port is enabled, the system is restarted for some reason. When this happens, the blade is reset and the blade is rebooted. At that time, the VLAN setting is initialized, and unless the VLAN setting is performed again by the user, a loop connection will be generated due to the port being enabled.

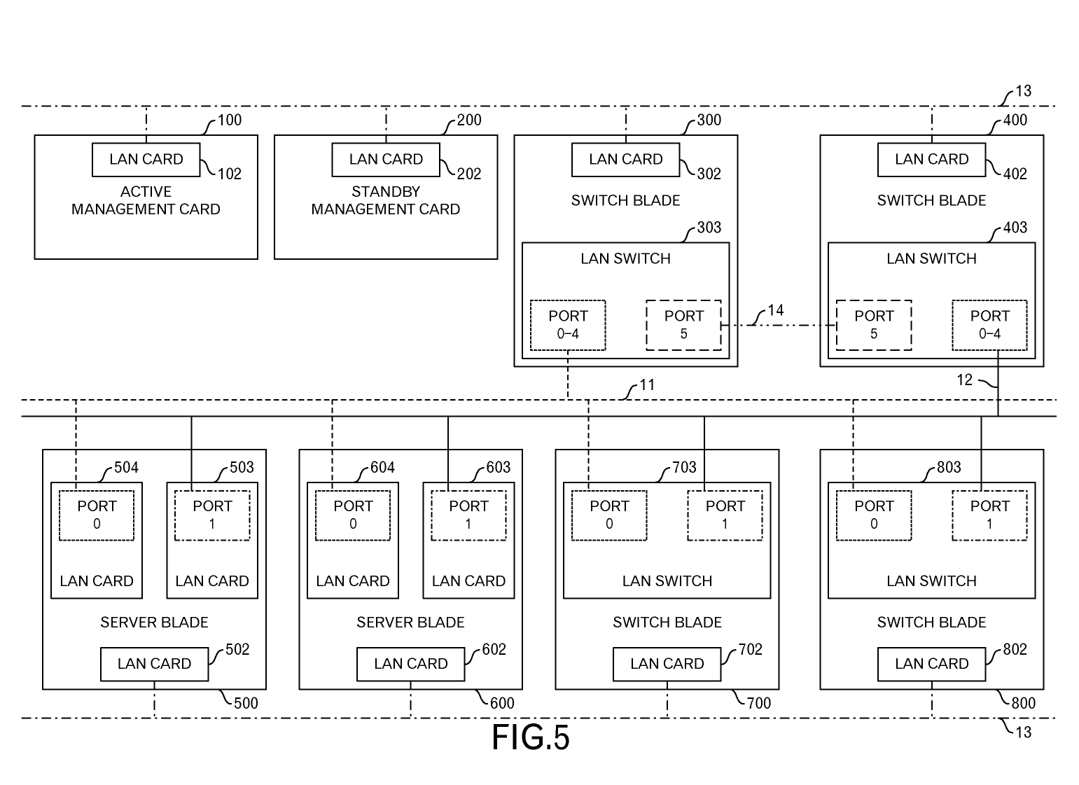

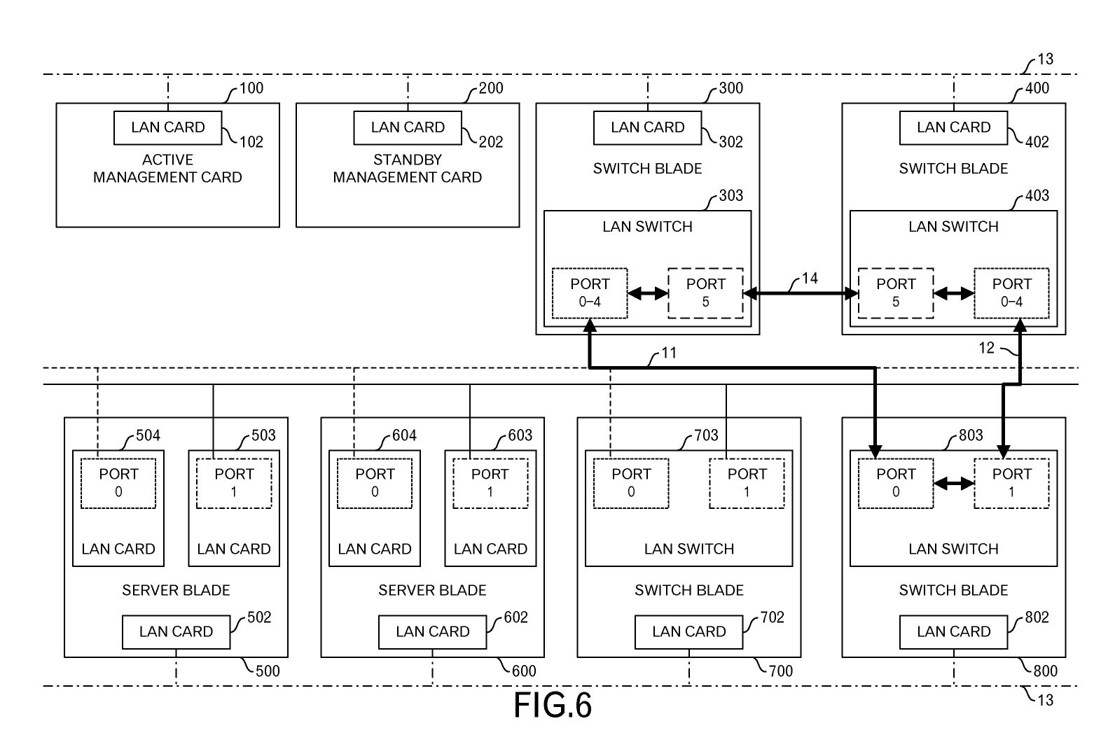

The form of the loop connection will be explained in detail using FIG. 5 and FIG. 6. First, FIG. 5 illustrates an example of a block diagram of a blade server. In the example of FIG. 5, an active management card 100, a standby management card 200, a switch blade 300, a switch blade 400, a server blade 500, a server blade 600, a switch blade 700, and a switch blade 800 are connected by way of Ethernet (registered trademark) networks 11 to 14 or the like.

Ports 0 to 4 of the switch blade 300, port 0 of the server blade 500, port 0 of the server blade 600, port 0 of the switch blade 700 and port 0 of the switch blade 800 are connected to a network 11 represented by a dashed line.

Ports 0 to 4 of the switch blade 400, port 1 of the server blade 500, port 1 of the server blade 600, port 1 of the switch blade 700 and port 1 of the switch blade 800 are connected to a network 12 represented by a solid line.

A port of the LAN card 102 in the active management card 100, a port of the LAN card 202 in the standby management card 200, a port of the LAN card 302 in the switch blade 300, a port of the LAN card 402 in the switch blade 400, a port of the LAN card 502 in the server blade 500, a port of the LAN card 602 in server blade 600, a port of the LAN card 702 in the switch blade 700, and a port of the LAN card 802 in the switch blade 800 are connected to a network 13 represented by a one-dot chain line.

Port 5 of the LAN switch 303 in the switch blade 300, and port 5 of the LAN switch 403 in the switch blade 400 are connected to a network 14 that is represented by the two-dot chain line.

Assume that a loop connection is generated in the blade server illustrated in FIG. 5 due to a cause such as illustrated in FIG. 3 or FIG. 4, for example. FIG. 6 illustrates an example of a loop connection in a blade server. In the example in FIG. 6, ports 0 to 4 and port 5 in the LAN switch 303 are not logically divided, ports 0 to 4 and port 5 in the LAN switch 403 are not logically divided, and port 0 and port 1 in the LAN switch 803 are not logically divided. Therefore, as illustrated by the bold lines, a loop connection occurs among LAN switch 303, LAN switch 403 and LAN switch 803.

The phenomenon of plural ports being connected in one blade does not occur when ports are physically divided as in the case of server blades 500 and 600. However, plural ports are included in one LAN switch as in the case of switch blades 300 and 400 and switch blades 700 and 800, and when those ports are not physically divided, it is not possible to divide the connections between those ports unless a VLAN is set.

In the following, a method for ensuring that a loop connection is not generated in a blade server in which a blade having a function of a switch function is mounted will be explained.

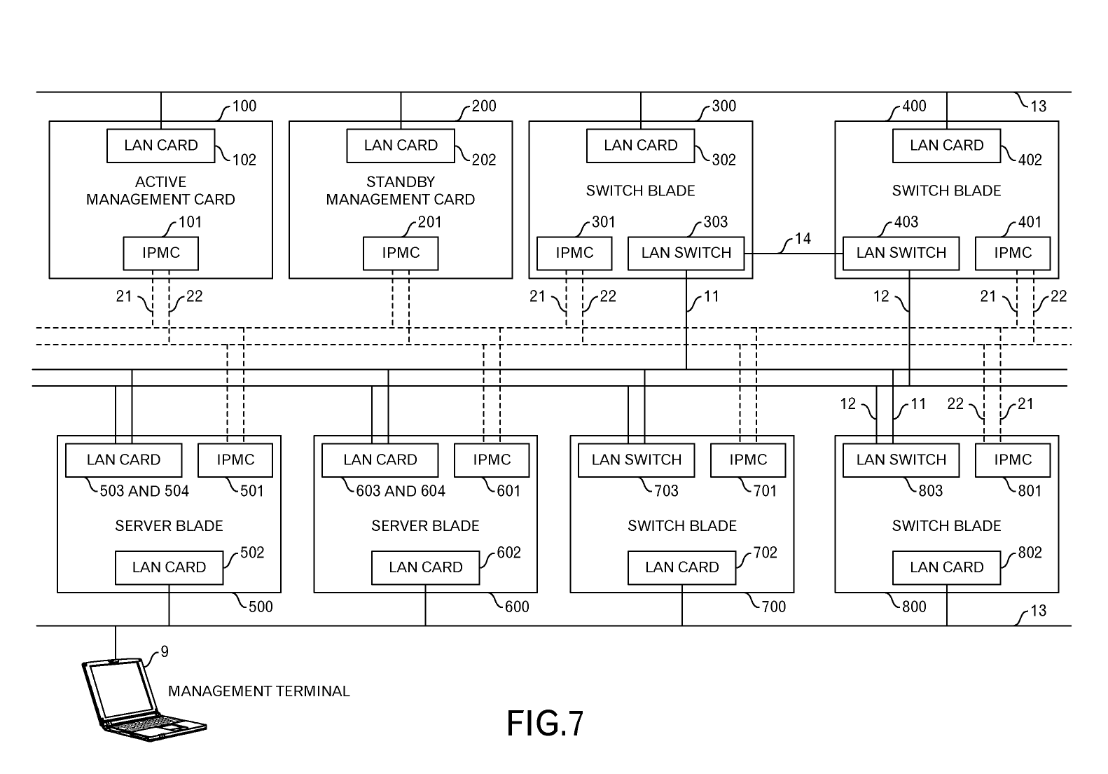

FIG. 7 is a block diagram of a blade server in this embodiment. The blade server in this embodiment includes an active management card 100, a standby management card 200, a switch blade 300, a switch blade 400, a server blade 500, a server blade 600, a switch blade 700, a switch blade 800, and a management terminal 9. The standby management card 200 executes processing in the place of the active management card 100 when processing by the active management card 100 is stopped due to an error. The user performs a VLAN setting for a blade by operating the management terminal 9.

The active management card 100 includes an IPMC 101 that is a controller for managing blades, and a LAN card 102. The standby management card 200 includes an IPMC 201 and a LAN card 202. The switch blade 300 includes an IPMC 301, a LAN card 302, and a LAN switch 303. The switch blade 400 includes an IPMC 401, a LAN card 402, and a LAN switch 403. The server blade 500 includes an IPMC 501, a LAN card 502 and LAN cards 503 and 504. The server blade 600 includes an IPMC 601, a LAN card 602, and LAN cards 603 and 604. LAN cards 503 and 504, and LAN cards 603 and 604 are illustrated as being one block so that it is easier to view the figure, however, actually they are physically independent two LAN cards.

Networks 11 to 14 are an Ethernet (registered trademark), for example. The LAN switch 303 in the switch blade 300, the LAN card 504 in the server blade 500, the LAN card 604 in the server blade 600, the LAN switch 703 in the switch blade 700, and the LAN switch 803 in the switch blade 800 are connected to the network 11.

The LAN switch 403 in the switch blade 400, the LAN card 503 in the server blade 500, the LAN card 603 in the server blade 600, the LAN switch 703 in the switch blade 700, and the LAN switch 803 in the switch blade 800 are connected to the network 12.

The LAN card 102 in the active management card 100, the LAN card 202 in the standby management card 200, the LAN card 302 in the switch blade 300, the LAN card 402 in the switch blade 400, the LAN card 502 in the server blade 500, the LAN card 602 in the server blade 600, the LAN card 702 in the switch blade 700, the LAN card 802 in the switch blade 800, and the management terminal 9 are connected to the network 13.

The LAN switch 303 in the switch blade 300, and the LAN switch 403 in the switch blade 400 are connected to the network 14.

An IPMB 21 and an IPMB 22 are buses for the active management card 100 to manage the temperature, voltage, power supply, hardware and software errors, or port information and the like of the blades, and redundancy increases due to duplication. The IPMC 101 in the active management card 100, the IPMC 201 in the standby management card 200, the IPMC 301 in the switch blade 300, the IPMC 401 in the switch blade 400, the IPMC 501 in the server blade 500, the IPMC 601 in the server blade 600, the IPMC 701 in the switch blade 700, and the IPMC 801 in the switch blade 800 are connected to the IPMB 21 and the IPMB 22.

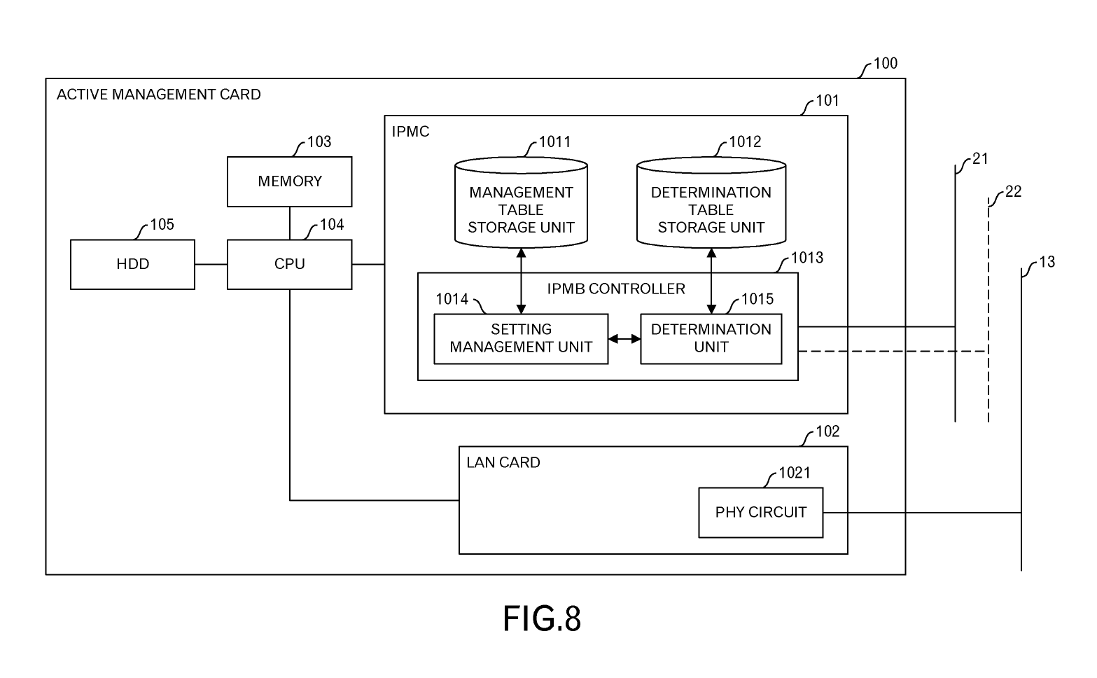

FIG. 8 is a block diagram of the active management card 100. The active management card 100 includes a LAN card 102 that includes a PHY circuit 1021, an IPMC 101, a memory 103, a CPU 104, and a Hard Disk Drive (HDD) 105. The memory 103, HDD 105, IPMC 101 and LAN card 102 are connected to the CPU 104. It is not illustrated in the figure; however, a port is included in the LAN card 102. A block diagram of the standby management card 200 is the same as the block diagram of the active management card 100.

The IPMC 101 includes an IPMB controller 1013 that includes a setting management unit 1014 and a determination unit 1015, a management table storage unit 1011, and a determination table storage unit 1012. The management table storage unit 1011 and the determination table storage unit 1012 are provided, for example, in a memory or the like of the IPMC 101. The IPMB 21 represented by a solid line, and the IPMB 22 represented by a dashed line are connected to the IPMB controller 1013. The network 13 that is represented by a solid line is connected to the PHY circuit 1021.

The setting management unit 1014 in the IPMC 101 manages data for blades 300 to 800 in the management table storage unit 1011. The determination unit 1015 in the IPMC 101 executes processing for determining whether or not a port is usable based on data that is stored in the management table storage unit 1011 and data that is stored in the determination table storage unit 1012. The PHY circuit 1021 in the LAN card 102 executes processing for a physical layer in data transfer.

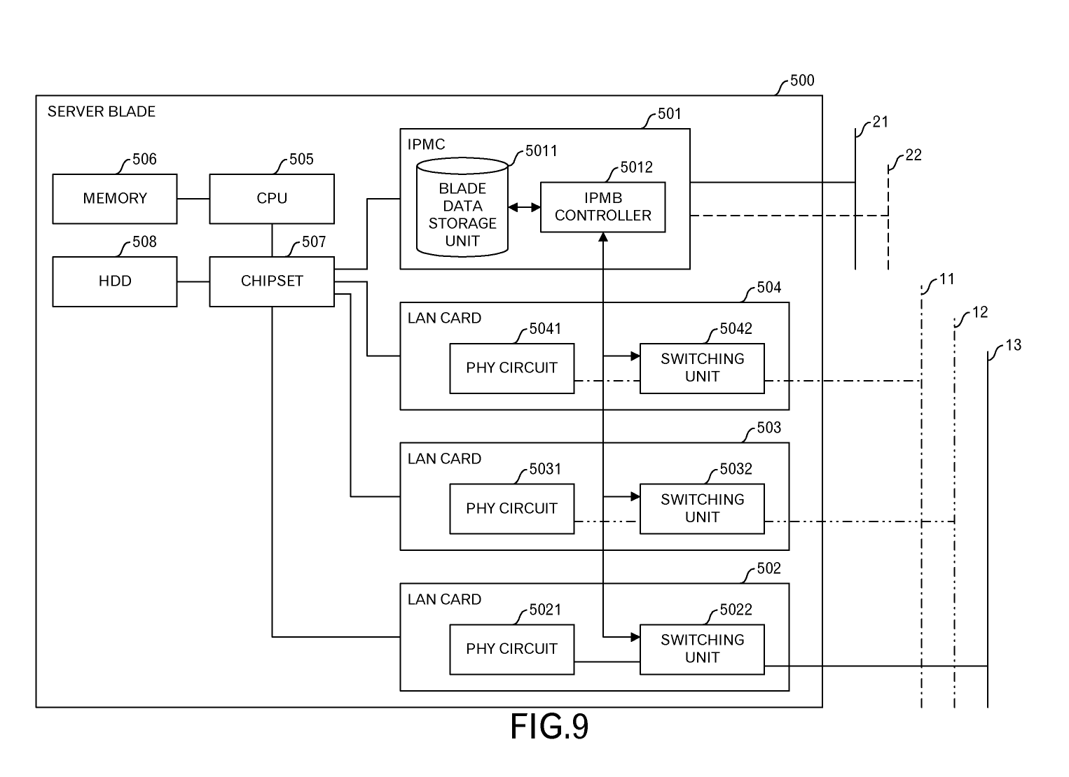

FIG. 9 illustrates a block diagram of server blade 500. The server blade 500 includes an IPMC 501, a LAN card 502 that includes a PHY circuit 5021 and switching unit 5022, a LAN card 503 that includes a PHY circuit 5031 and switching unit 5032, a LAN card 504 that includes a PHY circuit 5041 and switching unit 5042, a CPU 505, a memory 506, a chipset 507 and a HDD 508. It is not illustrated in the figure, however LAN cards 502 to 504 include ports. The block diagram of the server blade 600 is the same as the block diagram of the server blade 500.

The IPMC 501 includes a blade data storage unit 5011 and an IPMB controller 5012. The blade data storage unit 5011 is provided, for example, in a memory or the like of the IPMC 501. The IPMB 21 represented by a solid line, and the IPMB 22 represented by a dashed line are connected to the IPMC 501. The network 13 that is represented by the solid line is connected to the PHY circuit 5021 and the switching unit 5022. The network 12 that is represented by the two-dot chain line is connected to the PHY circuit 5031 and the switching unit 5032. The network 11 that is represented by the one-dot chain line is connected to the PHY circuit 5041 and the switching unit 5042.

The IPMB controller 5012 executes processing for transmitting data that is stored in the blade data storage unit 5011 to the active management card 100 by way of the IPMB 21 and IPMB 22. The switching unit 5022, the switching unit 5032 and the switching unit 5042 execute processing for switching ON/OFF of communication from the ports of the LAN cards. The PHY circuit 5021, the PHY circuit 5031 and the PHY circuit 5041 execute processing for the physical layers in data transfer.

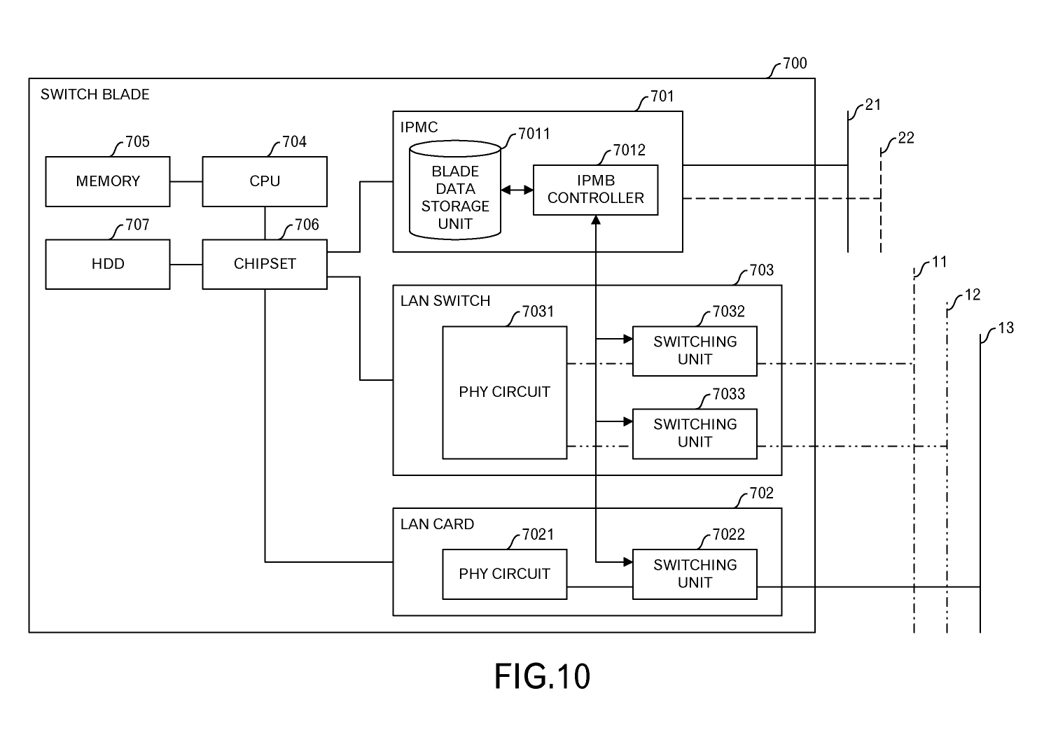

FIG. 10 illustrates a block diagram of the switch blade 700. The switch blade 700 includes an IPMC 701, a LAN card 702 that includes a PHY circuit 7021 and switching unit 7022, a LAN switch 703 that includes a PHY circuit 7031, a switching unit 7032 and a switching unit 7033, a CPU 704, a memory 705, a chipset 706 and a HDD 707. It is not illustrated in the figure, however, the LAN card 702 and LAN switch 703 include ports. Ports corresponding to each switching unit are provided in the LAN switch 703. Therefore, plural ports are provided. Block diagrams for the switch blades 300, 400 and 800 are the same as the block diagram for the switch blade 700. Moreover, in FIG. 10, the number of switching units and ports in the LAN switch 703 is two, however, the number is not limited.

The IPMC 701 includes a blade data storage unit 7011 and an IPMB controller 7012. The blade data storage unit 7011 is provided, for example, in a memory or the like of the IPMC 701. The IPMB 21 that is represented by the solid line, and the IPMB 22 that is represented by the dashed line are connected to the IPMC 701. The network 13 that is represented by the solid line is connected to the PHY circuit 7021 and the switching unit 7022. The network 11 that is represented by the one-dot chain line is connected to the PHY circuit 7031 and the switching unit 7032. The network 12 that is represented by the two-dot chain line is connected to the PHY circuit 7031 and the switching unit 7033.

The IPMB controller 7012 executes processing for transmitting data that is stored in the blade data storage unit 7011 to the active management card 100 by way of the IPMB 21 and IPMB 22. The switching unit 7022, the switching unit 7032 and the switching unit 7033 execute processing for switching ON/OFF of communication from the ports of the LAN cards or the LAN switches. The PHY circuit 7021 and the PHY circuit 7031 execute processing for the physical layers in data transfer.

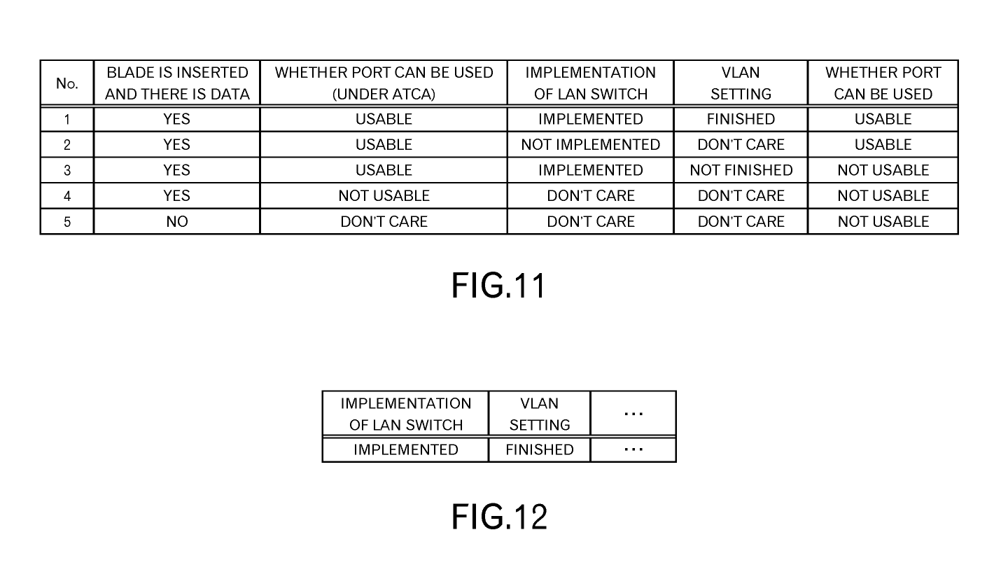

FIG. 11 illustrates an example of a determination table that is stored in the determination table storage unit 1012 in the active management card 100. In the example in FIG. 11, a number for identifying a combination pattern, information representing whether or not a conditions that a blade has been inserted and data (here, implementation data for a LAN switch and information representing whether a VLAN setting has been finished) has been obtained is satisfied, information representing whether or not a port can be used under ATCA, information representing whether or not a LAN switch is implemented, information representing whether or not a VLAN setting is complete, and information representing whether or not a port can be used at last. The determination unit 1015 determines whether or not a port can be used by determining whether a blade being activated corresponds to which pattern. “DON'T CARE” means that data stored in the field does not affect a final result of whether or not the port can be used.

In normal ATCA, when it is determined that a port “can be used” in accordance with ATCA, use of the port is allowed. However, in this embodiment, in the case of the pattern of No. 3, even though it is determined that a port “can be used” in accordance with ATCA, use of the port is not allowed when the VLAN setting has not been performed.

FIG. 12 illustrates an example of data that is stored in the blade data storage units in the server blades and switch blades. In the example in FIG. 12, information that represents whether or not a LAN switch is implemented, and information that represents whether or not a VLAN setting has been finished are included. Other information related to a blade (for example blade-type data, power data or the like) is also stored in the blade data storage unit, however, that information is not related to the main part of this embodiment, and it is omitted here.

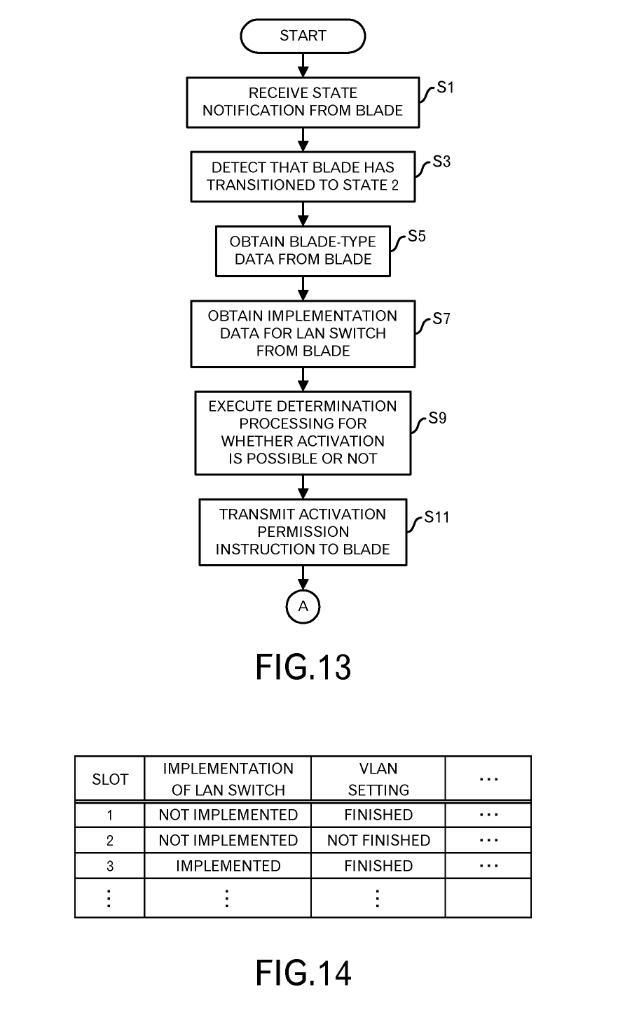

Next, processing that is executed when the active management card 100 activates a blade will be explained using FIGS. 13 to 19.

First, the setting management unit 1014 in the active management card 100 receives a state notification from a blade (FIG. 13: step S1). The state notification is a message for notifying the active management card 100 of which of the states 1 to 4 that the blade has transitioned to. In ATCA, besides the state notification, there are also other messages that the active management card 100 receives from a blade.

Here, assume that the state notification is a message representing that the blade has transitioned to state 2. Therefore, the setting management unit 1014 detects that the blade that is the transmission source of the state notification has transitioned to state 2 (step S3).

The setting management unit 1014 obtains blade-type data from the blade that is the transmission source of the state notification (step S5), and stores, in association with the number of the slot where that blade is inserted, that blade-type data in the management table storage unit 1011.

FIG. 14 illustrates an example of data that is stored in the management table storage unit 1011. In the example in FIG. 14, the number of a slot where the blade is inserted, information representing whether or not a LAN switch is implemented, and information representing whether or not a VLAN setting has been finished are stored. As described here, the active management card 100 manages blade data for each of the plural blades that are mounted in the blade server. When a blade is removed from a slot, blade data of the blade that was in that slot is deleted from the management table storage unit 1011.

The setting management unit 1014 obtains implementation data for a LAN switch from the blade that is the transmission source of the state notification (step S7), and stores, in association with the number of the slot where that blade is inserted, that implementation data in the management table storage unit 1011. For example, when the blade that is the transmission source of the state notification has a function of a LAN switch (in other words, the blade is one of switch blades 300 and 400, and 700 and 800), implementation data that represents that a LAN switch is implemented is obtained.

Then, the setting management unit 1014 uses the blade-type data that is stored in the management table storage unit 1011 to execute determination processing to determine whether or not activation is possible (step S9). Here, whether or not activation is possible is determined according to whether or not the blade is of a type that can be controlled by the active management card 100.

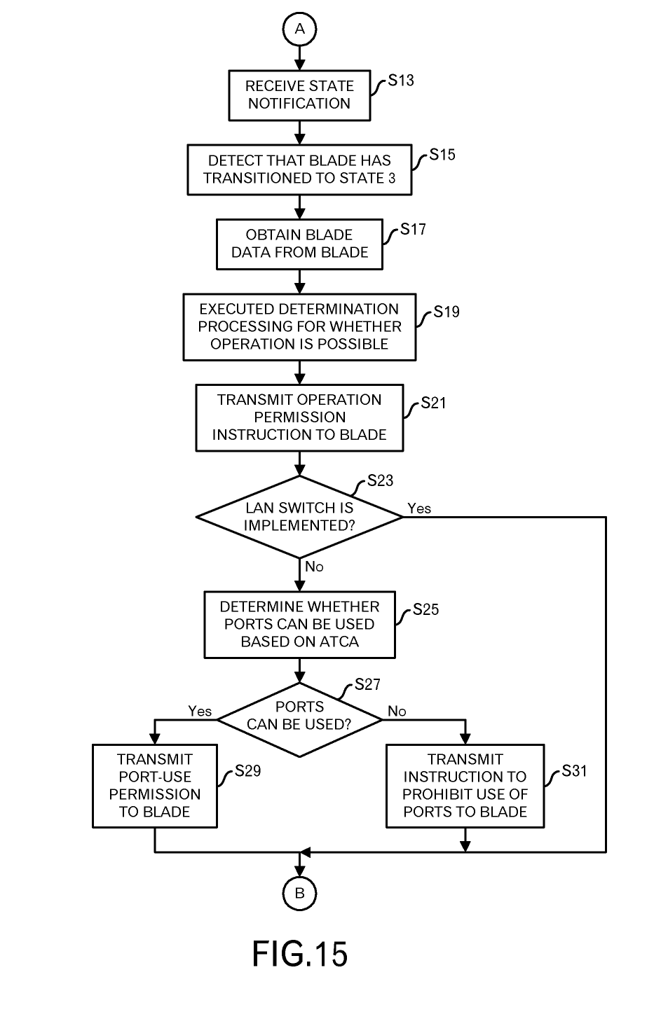

When the blade is of a type that can be controlled by the active management card 100, the setting management unit 1014 transmits, to the blade that is the transmission source of the state notification, an activation permission instruction that gives an instruction to activate (step S11). Processing then shifts to step S13 in FIG. 15 by way of terminal A.

Accordingly, the blade that is the transmission source of the state notification transitions to state 3, and transmits, to the active management card 100, a state notification representing that the blade has transitioned to state 3.

Shifting to the explanation of FIG. 15, the setting management unit 1014 receives the state notification from the blade (step S13). Here, assume that the state notification is a message representing that the blade has transitioned to state 3. Therefore, the setting management unit 1014 detects that the blade that is the transmission source of the state notification has transitioned to state 3 (step S15).

The setting management unit 1014 obtains blade data from the blade that is the transmission source of the state notification (step S17), and stores, in association with the number of the slot where that blade is inserted, the blade data in the management table storage unit 1011. For example, information for the communication standard of the ports in the blade, power data for calculating the power distribution and the like are included in the blade data.

Then, the setting management unit 1014 executes determination processing for determining whether or not operation is possible (step S19). In the step S19, whether or not operation is possible is determined according to power distribution that is calculated from the power data that is included in the blade data.

When operation is possible, the setting management unit 1014 transmits an operation permission instruction to the blade that is the transmission source of the state notification (step S21).

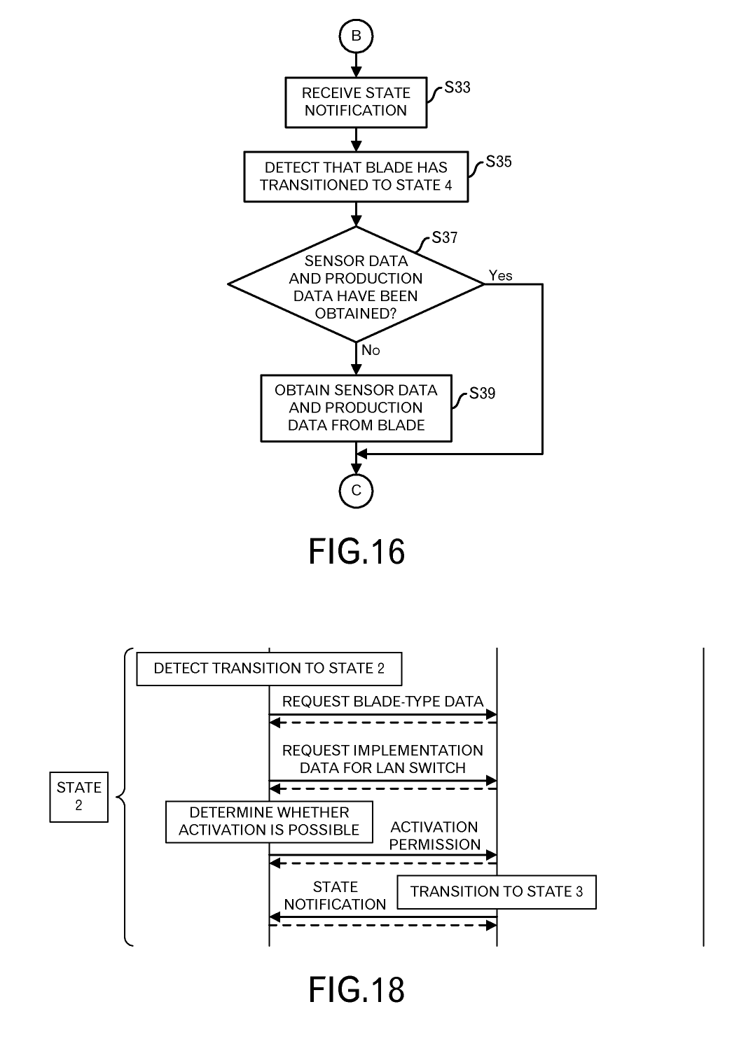

Then, the setting management unit 1014 determines whether the blade that is the transmission source of the state notification includes an implemented LAN switch (step S23). The determination in the step S23 is performed according to whether or not there is implementation data for the LAN switch stored in the management table storage unit 1011. When the LAN switch is implemented (step S23: YES route), determination of whether or not the ports can be used based on normal ATCA is not performed. Therefore, processing shifts to the step S33 in FIG. 16 by way of terminal B.

On the other hand, when there is no implemented LAN switch (step S23: NO route), the setting management unit 1014 instructs the determination unit 1015 to determine whether or not the ports can be used based on ATCA. Accordingly, the determination unit 1015 determines whether or not the ports can be used based on normal ATCA (step S25), and updates data that is stored in the management table storage unit 1011 based on the determination result. In the step S25, the determination is performed according to whether or not the communication standard of the ports in the blade that is the transmission source of the state notification coincides with the communication standard of the ports opposing the ports in the blade that is the transmission source of the state notification.

When the ports can be used in the blade that is the transmission source of the state notification (step S27: YES route), the determination unit 1015 transmits, to the blade that is the transmission source of the state notification, port-use permission that allows the use of the ports (step S29). The blade that receives the port-use permission starts using the ports after the ports have been enabled by a setting from the user.

On the other hand, when the ports cannot be used in the blade that is the transmission source of the state notification (step S27: NO route), the determination unit 1015 transmits, to that blade that is the transmission source of the state notification, an instruction that prohibits the use of the ports in that blade (step S31). Processing then shifts to step S33 in FIG. 16 by way of terminal B.

Accordingly, the blade that is the transmission source of the state notification transitions to state 4, and transmits, to the active management card 100, a state notification representing that the blade has transitioned to state 4.

Shifting to an explanation of FIG. 16, the setting management unit 1014 receives the state notification from the blade (step S33). Here, the state notification is a message that represents that the blade has transitioned to state 4. Therefore, the setting management unit 1014 detects that the blade that is the transmission source of the state notification has transitioned to state 4 (step S35).

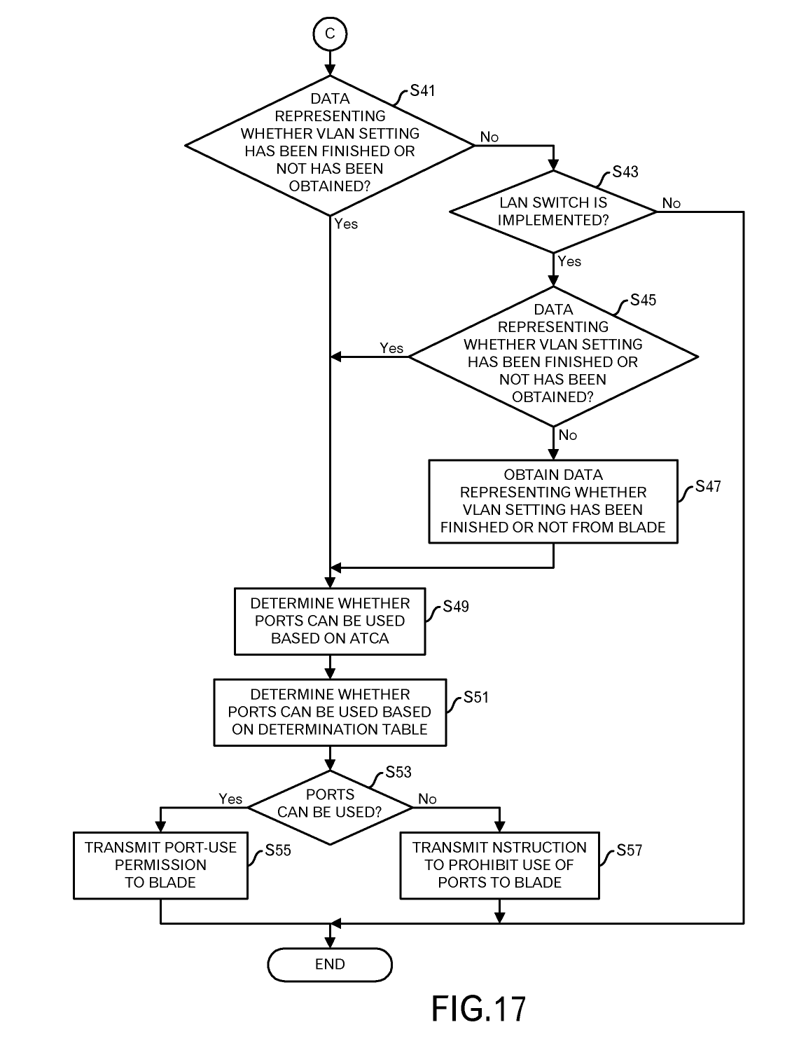

The setting management unit 1014 determines whether sensor data and production data have been obtained from the blade that is the transmission source of the state notification (step S37). In the step S37, determination is performed according to whether or not the sensor data and production data have been stored in the management table storage unit 1011. When the sensor data and production data have been obtained (step S37: YES route), the data does not have to be newly obtained. Therefore, processing shifts to step S41 in FIG. 17 by way of terminal C. However, when the sensor data and production data have not been obtained (step S37: NO route), the setting management unit 1014 obtains sensor data and production data from the blade that is the transmission source of the state notification (step S39), and stores, in association with the number of the slot where the blade is inserted, that data in the management table storage unit 1011.

Shifting to an explanation of FIG. 17, the setting management unit 1014 determines whether information that represents whether or not a VLAN setting has been completed has been obtained from the blade that is the transmission source of the state notification (step S41). In the step S41, determination is performed according to whether or not information that represents whether or not the VLAN setting has been completed is stored in the management table storage unit 1011. When information that represents whether or not the VLAN setting has been completed has been obtained (step S41: YES route), the processing shifts to step S49 in order to determine whether or not the ports can be used. On the other hand, when information that represents whether or not the VLAN setting has been completed has not been obtained (step S41: NO route), the setting management unit 1014 determines whether the blade that is the transmission source of the state notification includes an implemented LAN switch (step S43). In the step S43, information representing whether or not the VLAN setting is complete from the blade may be obtained.

When a LAN switch is not implemented (step S43: NO route), there is no loop connection caused by the blade that is the transmission source of the state notification. Therefore, the processing ends. In the processing of the step S25, it has already been determined whether or not the ports can be used for the blade that does not have an LAN switch.

On the other hand, when a LAN switch is implemented (step S43: YES route), the setting management unit 1014 determines whether information that represents whether or not the VLAN setting is complete has been obtained (step S45). The same processing is also performed in the step S41, however, as was described above, obtaining the information is sometimes performed during the time from after the end of the step S41 until the processing of the step S45 is executed. Therefore, the processing of the step S45 is performed just in case.

When it has been obtained (step S45: YES route), it may not be obtained again. Therefore, the processing shifts to the processing of step S49. On the other hand, when it has not been obtained (step S45: NO route), the setting management unit 1014 obtains, from the blade that is the transmission source of the state notification, information that represents whether or not the VLAN setting has been completed (step S47), and stores, in association with the number of the slot where the blade is inserted, the information in the management table storage unit 1011.

Then, the setting management unit 1014 instructs the determination unit 1015 to determine whether or not the ports can be used. Accordingly, the determination unit 1015 determines whether or not the ports can be used based on normal ATCA (step S49), and updates the data that is stored in the management table storage unit 1011 based on the determination result. Moreover, the determination unit 1015 determines whether or not the ports in the blade that is the transmission source of the state notification can be used based on the determination table (step S51).

In the step S51, determination is performed according to whether the number in the determination table (FIG. 11) for the blade that is the transmission source of the state notification is 1 or 2. The condition “a blade is inserted and there is data” is satisfied at the timing that the processing of the step S51 is performed. Whether or not ports can be used based on ATCA is set in the step S49. “Implementation of a LAN switch” and “VLAN setting” are specified by data that is stored in the management table storage unit 1011.

When the ports can be used (step S53: YES route), the determination unit 1015 transmits port-use permission to the blade that is the transmission source of the state notification (step S55). In the blade that received the port-use permission, use of the ports is started after the ports have been enabled by a setting by the user.

On the other hand, when the ports cannot be used in the blade that is the transmission source of the state notification (step S53: NO route), the determination unit 1015 transmits, to the blade that is the transmission source of the state notification, an instruction preventing the use of the ports in that blade (step S57). The processing then ends.

When a VLAN setting is performed by the user, the blade that received the instruction preventing use of the ports notifies the active management card 100 that the VLAN setting has been performed. After being notified by the blade that the VLAN setting has been performed, the setting management unit 1014 obtains, from the blade, information representing whether or not VLAN setting is complete. When the VLAN setting is complete, the determination unit 1015 then transmits port-use permission to the blade. As a result, at the timing when the VLAN setting is complete, it becomes possible to also allow use of the ports in a blade that was not allowed to use the ports due to the VLAN not being set.

By executing processing such as described above, it is possible to use plural ports after confirming that the plural ports in a blade in which a function of a LAN switch is implemented have been logically divided. Therefore, it is possible to prevent the occurrence of a loop connection.

FIG. 18 illustrates a processing sequence of state 2 in this embodiment. When compared with state 2 that is illustrated in FIG. 2, in this embodiment, a process is added in which the active management card 100 requests implementation data for a LAN switch from a blade. When a LAN switch is implemented in the blade, in state 3, determining whether or not the ports can be used is not performed, but in state 4 determining whether or not the ports can be used is performed.

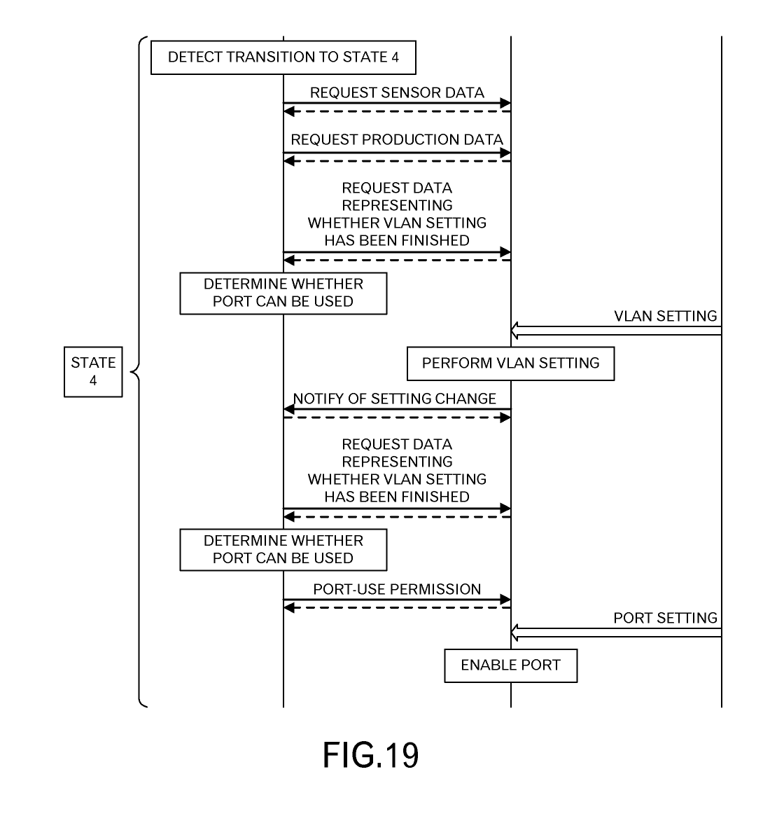

FIG. 19 illustrates a processing sequence for state 4 in this embodiment. When compared with state 4 in FIG. 2, in this embodiment, a process is added in which the active management card 100 requests a blade for data representing whether or not VLAN setting is complete. In the stage of the first processing, the VLAN setting is not performed, and port-use permission is not issued. However, after the first processing, the blade notifies that the VLAN setting was performed, and accordingly, the second processing is executed. Therefore, in the stage of the second processing, the VLAN setting has been performed and the port-use permission is issued. The ports is started to be used after the ports have been enabled by a user setting.

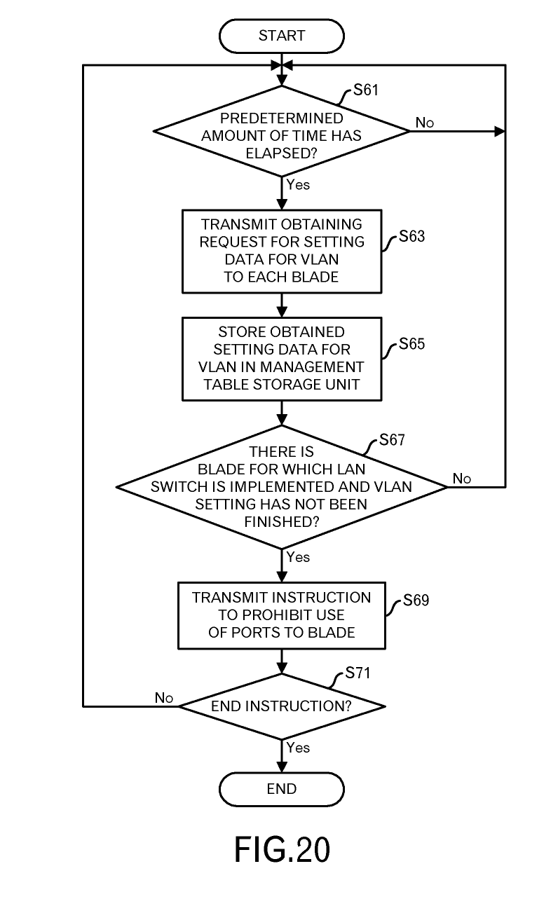

Next, FIG. 20 will be used to explain monitoring processing that is periodically executed by the active management card 100.

First, the setting management unit 1014 determines whether a predetermined amount of time (for example 60 seconds) has elapsed from the previous processing (FIG. 20: step S61).

When the predetermined amount of time has not elapsed (step S61: NO route), it is not yet the timing for executing processing. Therefore, the processing returns to the processing of the step S61. On the other hand, when the predetermined amount of time has elapsed (step S61: YES route), the setting management unit 1014 transmits, to each blade, an obtaining request that requests to obtain information representing whether or not the VLAN setting is complete (step S63). Accordingly, each blade transmits, to the active management card 100, information representing whether or not the VLAN setting is complete.

The setting management unit 1014 stores, in the management table storage unit 1011, the information representing whether or not the VLAN setting is complete, which was obtained from each blade (step S65).

The setting management unit 1014 uses the data that is stored in the management table storage unit 1011 to determine whether there is a blade for which a LAN switch is implemented and the VLAN setting is not complete (step S67). When there is no blade for which a LAN switch is implemented and the VLAN setting is not complete (step S67: NO route), a loop connection will not occur. Therefore, the processing returns to the processing of the step S61.

On the other hand, when there is a blade for which a LAN switch is implemented and the VLAN setting is not complete (step S67: YES route), the setting management unit 1014 instructs the determination unit 1015 to prohibit use of the ports in that blade. Accordingly, the determination unit 1015 transmits an instruction to that blade to prohibit use of the ports (step S69).

The setting management unit 1014 determines whether an end instruction to end processing has been received from the user (step S71). When an end instruction has not been received (step S71: NO route), the monitoring process continues, and processing returns to the processing of the step S61. On the other hand, when an end instruction has been received (step S71: YES route), processing ends.

By executing the processing described above, even in cases when, for some reason, the VLAN setting for a blade is initialized, it is possible to prevent use of the ports of that blade. Therefore, it is possible to prevent the occurrence of a loop connection.

Although the embodiments of this invention were explained above, this invention is not limited to those. For example, the functional block configurations of the active management card 100, the standby management card 200, the switch blade 300, the switch blade 400, the switch blade 700, the switch blade 800, the server blade 500, and the server blade 600, which are explained above, do not always correspond to actual program module configurations.

Moreover, the configurations of the respective tables are mere example, and may be changed. Furthermore, as for the processing flow, as long as the processing results do not change, the turns of the steps may be exchanged or the steps may be executed in parallel.

After the processing of the step S43 has been executed, processing may wait until a notification representing that the user has performed the VLAN setting is received from the blade, and the processing of the step S45 may be executed after the notification has been received.

Moreover, a program for the active management card 100 to execute the processing of this embodiment may be stored in a HDD 105, and the program may be executed by the CPU 104.

The aforementioned embodiments are outlined as follows:

An information processing apparatus relating to a first aspect of this embodiment includes: a memory; and a processor configured to use the memory and execute a process. And the process includes: (A) obtaining, from a first processing unit (for example, “a blade” in the embodiment) of plural processing units, first information representing whether or not the first processing unit has a function of a switch and second information representing whether or not a setting of a logical network for plural ports in the first processing unit has been completed; (B) determining whether or not the plural ports can be used, by using at least the first information and the second information; and transmitting, to the first processing unit, information representing that the plural ports can be used or cannot be used.

By performing processing as described above, it becomes possible to handle a problem in that a loop connection occurs due to connections among plural ports in a processing unit that has a function of a switch.

In addition, the transmitting may include: (b1) transmitting, to the first processing unit, information representing that the plural ports can be used, upon detecting that the first information represents that the first processing unit has the function of the switch and the second information represents that the setting of the logical network for the plural ports has been completed. By performing processing as described above, it becomes possible to prevent occurrence of the loop connection because plural ports in a processing unit that has a function of a switch are used after confirming that the plural ports are logically divided.

In addition, (b2) the transmitting may include: transmitting, to the first processing unit, information representing that the plural ports cannot be used, upon detecting that the first information represents that the first processing unit has the function of the switch and the second information represents that the setting of the logical network for the plural ports has not been completed. By performing processing as described above, it becomes possible to prevent occurrence of a loop connection because it becomes possible to avoid a situation in which plural ports in a processing unit that has a function of a switch are used though the plural ports are not logically divided.

Moreover, the transmitting may include: (b3) transmitting, to the first processing unit, information representing that the plural ports can be used, upon detecting that the first information represents that the first processing unit does not have the function of the switch. It becomes possible to begin using ports in spite of a setting of a logical network, because a processing unit does not cause a loop connection when the processing unit does not have a function of a switch.

Moreover, the determining may include: (b4) determining whether the plural ports satisfy a condition for a communication standard; and (b5) determining whether or not the plural ports can be used, by using a determination result for whether the plural ports satisfy the condition for the communication standard, the first information and the second information. By performing processing described above, it becomes possible to treat a standard in which whether ports can be used is determined based on a communication standard of the ports, for example ATCA.

In addition, the information processing apparatus and the plural processing units may be connected by IPMB (Intelligent Platform Management Bus). It becomes possible for a system realized by plural processing units to perform processing by utilizing IPMB, for example, when the system is a blade server in which blades are managed by IPMB.

An information processing method relating to a second aspect of this embodiment includes: (C) obtaining, from a first processing unit of plural processing units and by using a computer, first information representing whether or not the first processing unit has a function of a switch and second information representing whether or not a setting of a logical network for plural ports in the first processing unit has been completed; (D) determining, by using the computer, whether or not the plural ports can be used, by using at least the first information and the second information; and transmitting, to the first processing unit and by using the computer, information representing that the plural ports can be used or cannot be used.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus, comprising:
a memory; and
a processor configured to use the memory and execute a process, the process comprising:
obtaining, from a first processing unit of a plurality of processing units, first information representing whether or not the first processing unit has a function of a switch and second information representing whether or not a setting of a logical network for a plurality of ports in the first processing unit has been completed;
determining whether or not the plurality of ports can be used, by using at least the first information and the second information; and
transmitting, to the first processing unit, information representing that the plurality of ports can be used or cannot be used.

2. The information processing apparatus as set forth in claim 1, wherein the transmitting comprising:
transmitting, to the first processing unit, information representing that the plurality of ports can be used, upon detecting that the first information represents that the first processing unit has the function of the switch and the second information represents that the setting of the logical network for the plurality of ports has been completed.

3. The information processing apparatus as set forth in claim 1, wherein the transmitting comprising:
transmitting, to the first processing unit, information representing that the plurality of ports cannot be used, upon detecting that the first information represents that the first processing unit has the function of the switch and the second information represents that the setting of the logical network for the plurality of ports has not been completed.

4. The information processing apparatus as set forth in claim 1, wherein the transmitting comprising:
transmitting, to the first processing unit, information representing that the plurality of ports can be used, upon detecting that the first information represents that the first processing unit does not have the function of the switch.

5. The information processing apparatus as set forth in claim 1, wherein the determining comprising:
determining whether the plurality of ports satisfy a condition for a communication standard; and
determining whether or not the plurality of ports can be used, by using a determination result for whether the plurality of ports satisfy the condition for the communication standard, the first information and the second information.

6. The information processing apparatus as set forth in claim 1, wherein the information processing apparatus and the plurality of processing units are connected by IPMB (Intelligent Platform Management Bus).

7. An information processing method, comprising:
obtaining, from a first processing unit of a plurality of processing units and by using a computer, first information representing whether or not the first processing unit has a function of a switch and second information representing whether or not a setting of a logical network for a plurality of ports in the first processing unit has been completed;
determining, by using the computer, whether or not the plurality of ports can be used, by using at least the first information and the second information; and
transmitting, to the first processing unit and by using the computer, information representing that the plurality of ports can be used or cannot be used.

8. The information processing method as set forth in claim 7, wherein the transmitting comprising:
transmitting, to the first processing unit and by using the computer, information representing that the plurality of ports can be used, upon detecting that the first information represents that the first processing unit has the function of the switch and the second information represents that the setting of the logical network for the plurality of ports has been completed.

9. The information processing method as set forth in claim 7, wherein the transmitting comprising:
transmitting, to the first processing unit and by using the computer, information representing that the plurality of ports cannot be used, upon detecting that the first information represents that the first processing unit has the function of the switch and the second information represents that the setting of the logical network for the plurality of ports has not been completed.

10. The information processing method as set forth in claim 7, wherein the transmitting comprising:
transmitting, to the first processing unit and by using the computer, information representing that the plurality of ports can be used, upon detecting that the first information represents that the first processing unit does not have the function of the switch.

11. The information processing method as set forth in claim 7, wherein the determining comprising:
determining, by using the computer, whether the plurality of ports satisfy a condition for a communication standard; and
determining, by using the computer, whether or not the plurality of ports can be used, by using a determination result for whether the plurality of ports satisfy the condition for the communication standard, the first information and the second information.

12. The information processing method as set forth in claim 7, wherein the computer and the plurality of processing units are connected by IPMB (Intelligent Platform Management Bus).
